(19) United States
(12) Patent Application Publication
(10) Pub. No.: US 2016/0189558 A1
(43) Pub. Date: Jun. 30, 2016

(54) Learning Based on Simulations of Interactions of a Customer Contact Center

(71) Applicant: Genesys Telecommunications Laboratories, Inc., Daly City, CA (US)

(72) Inventors: Conor McGann, Daly City, CA (US); Herbert Willi Artur Ristock, Walnut Creek, CA (US); Yochai Konig, San Francisco, CA (US); Joe Eisner, Larkspur, CA (US); Vyacheslav Zhakov, Burlingame, CA (US)

(21) Appl. No.: 14/588,331

(22) Filed: Dec. 31, 2014

(51) Int. Cl. G09B 9/00

(52) U.S. Cl. CPC G09B 9/00

(57) ABSTRACT

A system and method for simulating an interaction between a customer and an agent of a customer contact center. A processor receives input conditions for simulating the interaction and generates a model of the customer based on the input conditions. The processor receives a first action from an agent device associated with the agent and updates a state of the simulation model based on the first action. The processor identifies a second action of the simulation model in response to the updated state, executes the second action, determines an outcome of the simulation, and provides the outcome to the agent device. In response to the outcome, the agent is prompted to take an action different from the second action.

### BACKGROUND

In the field of customer contact centers, it is desirable to get an understanding of a customer's needs or wants, and/or a sense of how an interaction with the customer will flow, prior to engaging in the actual interaction. Such knowledge helps make the interaction more efficient and effective. Accordingly, it is desirable to have a system and method for simulating an interaction with a customer prior to engaging in such interaction. The simulation may help the agent better prepare for the upcoming interaction. The simulation may also help the agent better determine the intent of the interaction and assess a confidence of its deduction prior to engaging in the interaction.

### SUMMARY

An embodiment of the present invention is directed to a system and method for simulating an interaction between a customer and an agent of a customer contact center. The system includes a processor and a memory, where the memory has instructions that, when executed by the processor, cause the processor to take the following actions. The processor receives input conditions for simulating the interaction and generates a model of the customer based on the input conditions. The processor receives a first action from an agent device associated with the agent and updates a state of the simulation model based on the first action. The processor identifies a second action of the simulation model in response to the updated state, executes the second action, determines an outcome of the simulation, and provides the outcome to the agent device. In response to the outcome, the agent is prompted to take an action different from the second action.

According to one embodiment, the simulation is invoked by a simulation controller accessible to the agent device for rehearsing a real interaction between the customer and the agent.

According to one embodiment, the processor receives feedback from the real interaction between the customer and the agent, and modifies the model of the customer based on the feedback.

According to one embodiment, the simulation is invoked by a simulation controller for training the agent for handling a particular type of interaction.

According to one embodiment, the input conditions for generating the model of the customer are based on the particular type of interaction for which the agent is to be trained.

According to one embodiment, the input conditions include an expected outcome of the simulation, and the processor compares the outcome of the simulation with the expected outcome, and generates a score for the agent based on the comparing.

According to one embodiment, the processor predicts a customer intent, wherein the input conditions include the predicted customer intent.

According to one embodiment, the identifying of the second action includes selecting the second action amongst a plurality of candidate actions.

According to one embodiment, the input conditions include an objective of the interaction, and the second action is for achieving the objective.

According to one embodiment, the processor dynamically modifies an agent script used by the agent to guide the agent during a particular interaction.

According to one embodiment, the system for simulating the interaction includes a clock for providing an output signal, wherein the output signal is included as part of the input conditions for simulating the interaction.

As a person of skill in the art should appreciate, the simulation allows an agent to take a dry-run of an interaction prior to engaging in the actual interaction. The simulation may help the agent better determine the intent of the interaction and assess a confidence of its deduction prior to engaging in the interaction. The simulation may also allow the agent to change an interaction strategy based on the output of the simulation, making the actual interaction more efficient and effective (e.g. to accomplish business goals).

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

FIG. 1 is a schematic block diagram of a customer simulation system according to one embodiment of the invention;

FIG. 2 is schematic block diagram of an interaction handling system according to one exemplary embodiment of the invention;

FIG. 3 is a schematic block diagram of a customer simulator according to one embodiment of the invention;

FIG. 4 is a flow diagram of a process for simulating an interaction with a customer model according to one embodiment of the invention;

FIG. 5 is a schematic block diagram of a customer and agent simulation system according to one embodiment of the invention;

FIG. 6A is a block diagram of a computing device according to an embodiment of the present invention;

FIG. 6B is a block diagram of a computing device according to an embodiment of the present invention;

FIG. 6C is a block diagram of a computing device according to an embodiment of the present invention;

FIG. 6D is a block diagram of a computing device according to an embodiment of the present invention; and

FIG. 6E is a block diagram of a network environment including several computing devices according to an embodiment of the present invention.

### DETAILED DESCRIPTION

Embodiments of the present invention are directed to a system and method that allows an agent to simulate an interaction with a customer prior to the agent actually engaging in the interaction. The simulation may help the agent better prepare for the upcoming interaction without impacting the real customer. The simulation may also help the agent better determine the intent of the interaction and assess a confidence of its deduction prior to engaging in the interaction.

According to one embodiment, the simulation is conducted while a customer waits in queue to talk to the agent, is browsing a website of an enterprise that the contact center supports, or the like. The simulation may test the outcome of agent actions to be taken during the real interaction. In another embodiment, the simulation may provide agent assistance by suggesting actions to be taken by the agent after the outcome of the suggested actions have been simulated.

Simulations may also be conducted offline for training purposes without a real customer waiting to interact with the agent. In this regard, a supervisor may evaluate an agent's performance in a test environment to prepare and train the agent for interactions with real customers. For example, the simulation may be used to train the agent to engage customers successfully in sales scenarios. The simulation may also be used to train the agent to engage with customers via a media channel for which the agent has not yet been validated. For example, an agent previously trained only for voice interactions may be trained to engage in chat interactions.

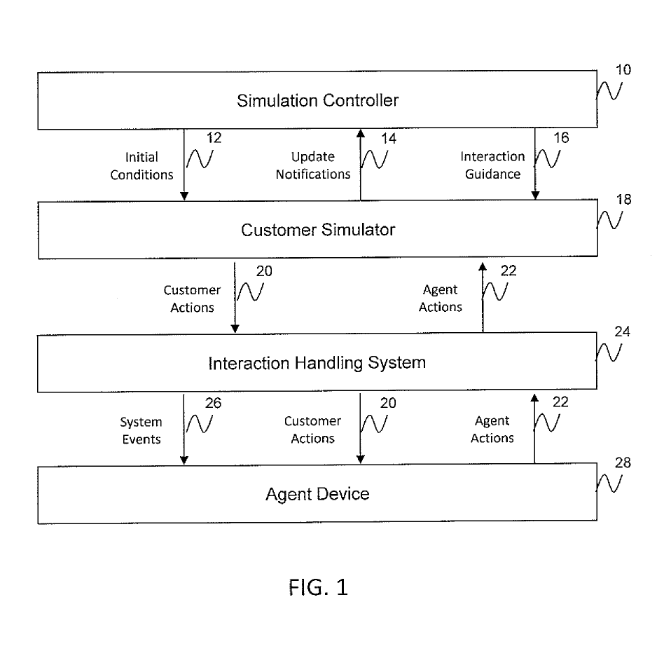

FIG. 1 is a schematic block diagram of a customer simulation system according to one embodiment of the invention. The system includes a simulation controller 10, customer simulator 18, interaction handling system 24, and an agent device 28. The simulation controller may be a computing device accessible to, for example, a supervisor or an agent of a contact center. In this regard, the simulation controller takes the form of a networked computer, laptop, tablet, or any other computing device conventional in the art.

The simulation controller 10 may include one or more software modules and necessary network connections for interacting with the customer simulator 12 to simulate an interaction with a customer. For example, the simulation controller 10 may be configured to generate initial conditions 12 for the simulation and forward such conditions to the customer simulator 18 for initiating a simulation with a customer model. The initial conditions may provide parameters that generate the customer model and/or scenario to be simulated. For example, the initial conditions may indicate the objectives and constraints of the simulation. The initial conditions may also provide a problem statement. The problem statement may indicate, for example, that the customer to be simulated has problems with a particular product or service bought from an enterprise supported by the contact center. In another embodiment, the system may be configured to predict a customer's intent, and feed the customer intent as the initial conditions to drive the model of customer behavior.

In embodiments where a specific customer is to be simulated, the initial conditions may be data extracted from his or her customer record, interaction history, recorded sessions, interaction assessments (e.g. after call notes input by agents), survey feedback, real-time observations from exposed activities (e.g. the customer's web browsing activities, search history, knowledgebase interactions, forum interactions, or activities provided by the customer's mobile device), social media, and the like. For example, collected data about the customer's behavior including the time of day of contact, location of contact, browsing history, and the like, may be used to identify other customers who exhibited similar behavior to learn from those other customers an interaction intent to be used as the current customer's intent for purposes of running the simulation.

Simulation of a real customer may be desirable to predict the outcome of a real interaction with the customer prior to engaging in the real interaction. If the outcome of the simulation is less than desirable, the agent, or his manager on his behalf, may choose to hold off on the interaction or have him change his strategy once the agent engages with the customer in the real interaction. The agent may also be able to reference the actual responses provided previously in similar situations, to learn what approaches did work in instances where his own recent attempts in the simulation did not work.

If the simulation is not of a specific customer, but of a generic/representative customer defined by an exemplary customer profile, the initial conditions 12 fed to the customer simulator may include attributes found in the exemplary customer profile along with a problem statement. For example, the initial conditions may indicate that the customer is a male “gold” customer in an “agitated” state who is having problems with his new iPhone.

As the simulation progresses, the simulation controller 10 may be configured to receive update notifications 14 from the customer simulator 18. The notification may be, for example, information on a current customer state, agent action, or the like. The notifications may be displayed on a display device coupled to the simulation controller. In this manner, a supervisor may observe how the simulation progresses through the various interaction phases and provide, for example, interaction guidance 16 to the customer simulator 18 as needed. The interaction guidance may, for example, trigger a transition to a next interaction phase (e.g. a next agitated phase of the customer), a next script of the interaction scenario, adjustment of the simulation, or the like. The interaction guidance may also be an input, for example, to resolve ambiguities of the interaction for making the interaction as real as possible. For example, if the agent, during the interaction, responds with a question, the customer simulator may be configured to automatically respond to the question based on the current customer model, or a supervisor may, via the simulation controller 10, feed the customer simulator 18 the answer that is to be used. In this regard, the model may allow for a mixed-initiative approach where human supervisors may, via the simulation controller 10, steer or augment the automated component of the customer simulator.

According to one embodiment, the simulation controller 10 has access to various databases and servers for formulating and providing the initial conditions 12 and interaction guidance 16 to the customer simulator 18 before and during a simulation. The databases and/or servers, may provide, for example, real-time activities of the customer. Such real-time activities may include the customer's browsing history on a web site of the enterprise supported by the contact center, comments posted by the customer on social media sites (e.g. Facebook or Twitter), and the like, which may provide additional information about a specific customer that is being simulated. As an example, if the specific customer is waiting in queue to interact with the customer, and while waiting, he or she browses on information on an airline enterprise's web site relating to “how to fly with pets,” an assumption may be made that the reason for the interaction is to get further information on how to fly with pets on the airline. Based on this information, the customer simulator may model the customer as one who owns pets and is about to take a flight.

The databases and/or server may also provide other information relevant to the simulation. Such other information might include related news in the media (e.g. talks about bending iPhones), a big sports event, or weather conditions at the customer's location. It may also include what is being discussed in social media groups the customer is member of, even if the customer does not post comments directly. The information may also include learning from recent interactions with other customers on the same/similar topic. Such learning may relate, for example, to customer intent based on similar behavior exhibited by the other customers.

Based on information gathered from the databases and/or server, the agent may then simulate an interaction with a customer to validate the intent for the interaction, and/or determine an outcome of the interaction. In some embodiments, in addition or in lieu to such a-priori simulation, the simulation may also be used during an actual interaction with the customer. In this regard, the model may be tuned/adjusted in real time by comparing the predicted behavior of the customer against the actual behavior. The simulation system may also serve as an “agent scripting” engine with real-time updates/adjustments to a script used by an agent to conduct a real interaction. In some embodiments, the simulation may be automated at both sides: the customer side and the agent side. For example, the agent side may be driven by a script. In one example, if at a given interaction state there are three options for the agent on how to conduct the interaction further, these three choices could be configured in the script, and at a particular trigger (e.g. an agent mouse click while he is engaged with the customer in a real interaction), the simulation may be run and a display provided to the agent of the rated outcomes for the three options. This may help the agent to select the best option.

According to one embodiment, the customer simulator 18 may take the form of a computer device having one or more processors, memory, input/output device, and network connectors. The customer simulator 18 is configured to model a customer based on the initial conditions 12 and interaction guidance 16 from the simulation controller 10. In this regard, the customer simulator may be referred to as a digital representation of a real customer.

As the customer simulator emulates the customer, it outputs customer actions 20 as a real customer would. Such actions may depend on the type of communication media for which simulation is being simulated. For example, if the interaction is simulated as a voice interaction, the customer actions 20 include voice utterances. If the interaction is simulated as a chat interaction, the customer actions 20 include text-based messages.

The customer actions 20 generated by the customer simulator 18 are responsive to agent actions 22 provided by an agent interacting with the customer simulator 18 via his agent device 28. Both the customer actions 20 and agent actions 22 are processed by the interaction handling system 24 as it would with a real interaction. In doing so, the interaction handling system generates system events 26 as it typically would in a real interaction. According to one embodiment, the interaction handling system 24 includes all servers and databases typically present in a contact center system for processing real interactions.

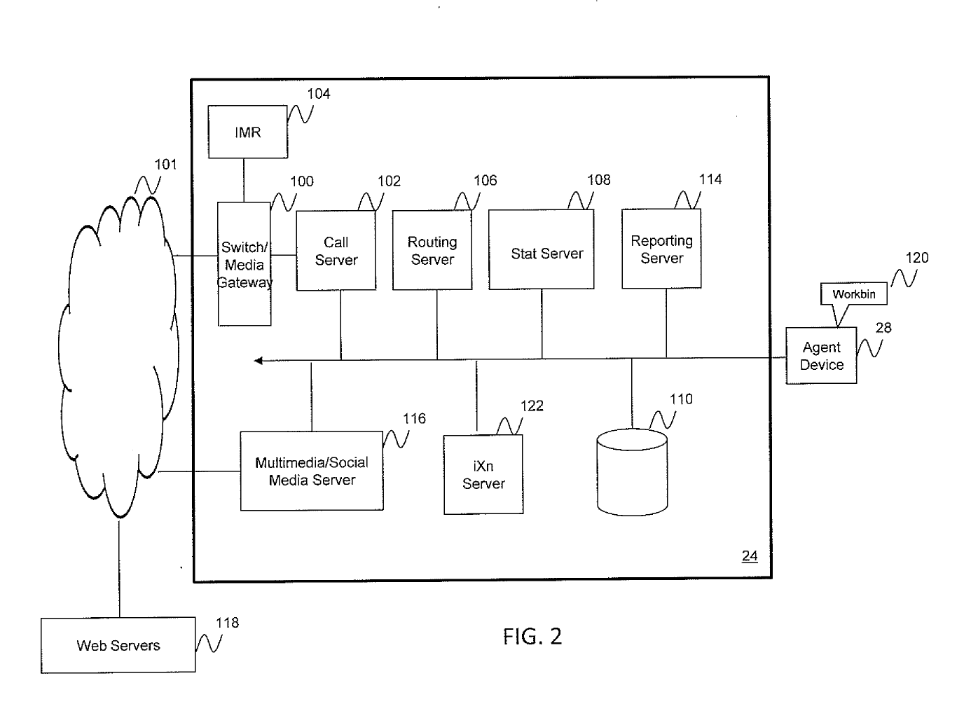

FIG. 2 is a more detailed block diagram of the interaction handling system 24 according to one exemplary embodiment of the invention. According to one exemplary embodiment, the interaction handling system includes a switch/media gateway 100 coupled to a communications network 101 for receiving and transmitting telephony calls between customers and the contact center. The switch/media gateway 100 may include a telephony switch configured to function as a central switch for agent level routing within the center. In this regard, the switch 100 may include an automatic call distributor, a private branch exchange (PBX), an IP-based software switch, and/or any other switch configured to receive Internet-sourced calls and/or telephone network-sourced calls. According to one exemplary embodiment of the invention, the switch is coupled to a call server 102 which may, for example, serve as an adapter or interface between the switch and the remainder of the routing, monitoring, and other call-handling components of the contact center.

The call server 102 may be configured to process PSTN calls, VoIP calls, and the like. For example, the call server 102 may include a session initiation protocol (SIP) server for processing SIP calls. According to some exemplary embodiments, the call server 102 may, for example, extract data about the customer interaction such as the caller's telephone number, often known as the automatic number identification (ANI) number, or the customer's internet protocol (IP) address, or email address, and communicate with other contact center components in processing the call.

According to one exemplary embodiment of the invention, the interaction handling system 24 further includes an interactive media response (IMR) server 104, which may also be referred to as a self-help system, virtual assistant, or the like. The IMR server 104 may be similar to an interactive voice response (IVR) server, except that the IMR server is not restricted to voice, but may cover a variety of media channels including voice. Taking voice as an example, however, the IMR server may be configured with an IMR script for querying calling customers on their needs. For example, a contact center for a bank may tell callers, via the IMR script, to “press 1” if they wish to get an account balance. If this is the case, through continued interaction with the IMR, customers may complete service without needing to speak with an agent. The IMR server 104 may also ask an open ended question such as, for example, “How can I help you?” and the customer may speak or otherwise enter a reason for contacting the contact center.

The routing server 106 may be configured to take appropriate action for processing a call, whether from a real customer or from a customer simulator 18. For example, the routing server 106 may use data about the call to determine how the call should be routed. If the call is to be routed to a contact center agent, the routing server 106 may select an agent for routing the call based, for example, on a routing strategy employed by the routing server 106, and further based on information about agent availability, skills, and other routing parameters provided, for example, by a statistics server 108.

In some embodiments, the routing server 106 may query a customer database, which stores information about existing clients, such as contact information, service level agreement (SLA) requirements, nature of previous customer contacts and actions taken by contact center to resolve any customer issues, and the like. The database may be managed by any database management system conventional in the art, such as Oracle, IBM DB2, Microsoft SQL server, Microsoft Access, PostgreSQL, MySQL, FoxPro, and SQLite, and may be stored in a mass storage device 110. The routing server 106 may query the customer information from the customer database via an ANI or any other information collected by the IMR 104.

According to one embodiment the statistics server 108 or a separate presence server may be configured to provide agent availability information to all subscribing clients. Such clients may include, for example, the routing server 106, interaction (iXn) server 122, and/or the like.

Upon identification of an agent to whom to route the call, a connection is made between the caller and an agent device of an identified agent, such as, for example, the agent device 28 of FIG. 1, Received information about the caller and/or the caller's historical information may also be provided to the agent device for aiding the agent in better servicing the call. In this regard, the agent device 28 may include a telephone adapted for regular telephone calls, VoIP calls, and the like. The agent device 28 may also include a computer for communicating with one or more servers of the interaction handling system and performing data processing associated with contact center operations, and for interfacing with customers via voice and other multimedia communication mechanisms.

The interaction handling system 24 may also include a reporting server 114 configured to generate reports from data aggregated by the statistics server 108. Such reports may include near real-time reports or historical reports concerning the state of resources, such as, for example, average waiting time, abandonment rate, agent occupancy, and the like. The reports may be generated automatically or in response to specific requests from a requestor (e.g. agent/administrator, contact center application, and/or the like).

The interaction handling system 24 may also include a multimedia/social media server 116 for engaging in media interactions other than voice interactions with end user devices, web servers 118, and the customer simulator 18. The media interactions may be related, for example, to email, vmail (voice mail through email), chat, video, text-messaging, web, social media (whether entirely within the domain of the enterprise or that which is monitored but is outside the proprietary enterprise domain), co-browsing, and the like. The web servers 118 may include, for example, social interaction site hosts for a variety of known social interaction/media sites to which an end user may subscribe, such as, for example, Facebook, Twitter, and the like. The web servers may also provide web pages for the enterprise that is being supported by the contact center. End users may browse the web pages and get information about the enterprise's products and services. The web pages may also provide a mechanism for contacting the contact center, via, for example, web chat, support forum (whether specific to a certain product or service, or general in nature), voice call, email, web real time communication (WebRTC), or the like. According to one embodiment, actions of a customer on the web pages may be monitored via software embedded on the web site which provides the monitored information to a monitoring application hosted by, for example, the multimedia/social media server 116. The monitoring application may also receive information on user actions from social media sites such as Facebook, Twitter, and the like. Clients such as the simulation controller 10 may subscribe to receive the monitored data in real time.

According to one exemplary embodiment of the invention, in addition to real-time interactions, deferrable (also referred to as back-office or offline) interactions/activities may also be routed to the contact center agents. Such deferrable activities may include, for example, responding to emails, responding to letters, attending training seminars, or any other activity that does not entail real time communication with a customer. In this regard, the iXn server 122 interacts with the routing server 106 for selecting an appropriate agent to handle the activity. Once assigned to an agent, the activity may be pushed to the agent, or may appear in the agent's workbin 120 as a task to be completed by the agent. The agent's workbin may be implemented via any data structure conventional in the art, such as, for example, a linked list, array, and/or the like. The workbin may be maintained, for example, in buffer memory of the agent device 28.

According to one exemplary embodiment of the invention, the mass storage device(s) 110 may store one or more databases relating to agent data (e.g. agent profiles, schedules, etc.), customer data (e.g. customer profiles), interaction data (e.g. details of each interaction with a customer, including reason for the interaction, disposition data, time on hold, handle time, etc.), and the like. According to one embodiment, some of the data (e.g. customer profile data) may be maintained in a customer relations management (CRM) database hosted in the mass storage device 110 or elsewhere. The mass storage device may take form of a hard disk or disk array as is conventional in the art.

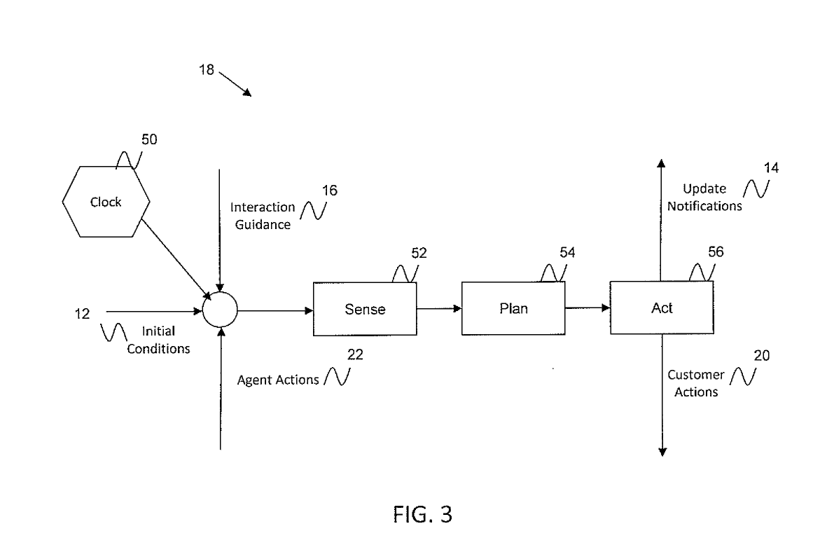

FIG. 3 is a schematic block diagram of the customer simulator 18 according to one embodiment of the invention. The customer simulator 18 includes a central processing unit (CPU) which executes software instructions and interacts with other system components to model a customer and allow an agent to interact with the modeled customer. The customer simulator 18 further includes an addressable memory for storing software instructions to be executed by the CPU. The memory is implemented using a standard memory device, such as a random access memory (RAM). In one embodiment, the memory stores a number of software objects or modules, including a sensing module 52, planning module 54, and action module 56. Although these modules are assumed to be separate functional units, a person of skill in the art will recognize that the functionality of the modules may be combined or integrated into a single module, or further subdivided into further sub-modules without departing from the spirit of the invention. The sensing, planning, and action modules are configured to carry out sensing, planning, and action steps at each evaluation point of a simulated interaction. The evaluation points may be driven by a clock 50 or by specific events.

According to one embodiment, the sensing step carried by the sensing module 52 updates a state model of the customer simulator given new inputs from the simulation controller 10 or interaction handling system 24. The inputs are provided in the form of initial conditions 12, interaction guidance 16, or agent actions 22. According to one embodiment, the updates may be direct updates of the simulator state model according to preset rules. The rule may say, for example, if a received input is X, then update the state model to Y.

In other embodiments, the updates entail advanced perception using predictive models to infer higher-level states from low-level inputs. The low-level inputs may include, for example, clock ticks from the clock 50. According to this embodiment, the sensing module 52 may be configured to engage in predictive analytics to infer the higher-level states based on the low-level inputs. Predictive analytics is described in further detail in http://en.wikipedia.org/wiki/Predictive_analytics, the content of which is incorporated herein by reference. Taking a clock tick as an example, the sensing module 52 may take a clock tick after having received a series of clock ticks to infer that the customer's mood should now transition from neutral to impatient. The simulated customer state relating to mood is thus updated accordingly.

According to one embodiment, the current simulation state model is represented as a probability distribution to take into account inherent uncertainty surrounding the sensing step. As further data is gathered at each evaluation point of the simulation, the sensing module 52 updates the probability distribution based on the gathered data. One of various well known mechanisms may be used to do the updating, including, for example, Hidden Markov models, neural networks, Bayesian networks, and the like.

Given the current simulation state, a planning step is carried out by the planning module 54. In this regard, the planning module 54 generates one or more next actions to take given a current state (or state history), and a set of goals/constraints. According to one embodiment, the planning module 54 applies one or more rules in selecting an action to take next.

The planning module 54 may be implemented via one of various mechanisms known in the art. According to one implementation, the planning module 54 may access preset rule specifications that statically map/describe what actions to take based on a current state. The rule specifications may be generated according to best practices known in the industry. According to this implementation, when a particular state is sensed, the planning module searches the rule specification to retrieve the action(s) that are mapped to the state.

According to another implementation, the planning module is configured to solve an optimization problem, searching over a range of outcomes and choosing the best plan based on the objectives/constraints given by the simulation controller 10. For example, the planning module may maintain a planning model, which, given a current state and a next goal state, generates a list of candidate actions and/or selects a best candidate action that will maximize the chances of achieving a next goal. Any one of various well known algorithms may be used for planning, including for example, Markov Decision Processes, Reinforcement Learning, and the like. The Markov Decision Process is described in further detail in http://en.wikipedia.org/wiki/Markov_decision_process, the content of which is incorporated herein by reference. Reinforcement Learning is described in more detail in http://en.wikipedia.org/wiki/Reinforcement_learning, the content of which is incorporated herein by reference.

In one example of planning according to a planning model, the model may adhere to a rule that states that if a customer is sensed to be in an agitated state, and more than 10 seconds pass after an initial message from the customer without receiving a response, candidate actions are to be generated in response. A first action generated by the planning model may be for the simulated customer to send another message asking if the agent is still there. A second action may be for the simulated customer to abandon the call. Yet a third action may be for the simulated customer to send a message with a strong complaint. According to one embodiment, the model may predict outcomes based on each candidate action and select a candidate action that is predicted to produce an optimal outcome.

According to one embodiment, the candidate actions that are generated by the planning model are constrained by the constraints given by the simulation controller 10. One such constraint may be, for example, an operational constraint. For example, a candidate action to start a chat session may be taken if there are agents available to handle the chat, or if an agent's device is configured for chat.

Once an action is selected as a next action to be taken, the implementation of the action is carried out by the action module 56. In this regard, the action module communicates with the interaction handling system 24 to dispatch an action to be taken. The action may be, for example, to send a chat message to an agent, abandon a current session, or the like. The actions may be implemented via one or more servers of the interaction handling system 24.

The action module 56 may further be configured to generate an update notification 14 to the simulation controller 10 based on the action that is taken. According to one embodiment, a particular update notification 14 is transmitted if an input, in the form of interaction guidance 16, is required from the simulation controller to proceed with the simulation. For example, the notification and subsequent guidance may be to answer a question posed by the agent.

There may be various reasons for invoking the customer simulator 18 and engaging in a simulated interaction with a customer model generated by the customer simulator. For example, the customer simulator 18 may be invoked by an agent to practice an interaction as a rehearsal to a real interaction with a particular customer. The agent may, for instance, want to try different strategies on how to conduct the interaction to see what the outcome of each strategy will be, without impacting the real customer. Trying out different strategies for doing an upsell, for example, may reveal that one strategy results in a successful upsell of a product while another strategy results in an unsuccessful upsell attempt.

In another example, an agent may want to engage in simulation with the customer simulator to predict conversation flow, such as, for example, the need to transfer an interaction, conference-in another agent, and the like. Appropriate preparation may be taken based on this prediction prior to engaging in the real interaction. For example, the agent may want to wait to engage in the real interaction until the other agent to whom the interaction may be transferred or conferenced-in, is available. The agent may also want to simulate an interaction to predict the need to take action during the interaction, such as, for example, the need for interaction recording.

In a further example, a simulation may be desirable to be run to check the quality of the profile data of a current customer that is being simulated. In this regard, the customer simulator 18 may impersonate a particular customer profile and the agent may engage in conversation with the customer simulator as he would with a real customer. The simulation may reveal that there is missing data about the current customer that should be added to the profile. This may apply, for example, to newly created profiles when the relevant parameters are still in a state of flux, or to existing profiles tuned to particular services when service conditions have changed (e.g. due to new laws or corporate policies). For example, an agent might have gotten training on a new service offering, and when applying this knowledge in the simulated customer interaction session, the agent may realize that a relevant attribute/parameter is missing. Similarly, the agent might have learned about importance of a particular parameter from a recent interaction with another customer. Such parameters may be changes in financial business such as Basel 3 which might imply changes in risk taking for customer credits, or changes in healthcare such as ACA, or the upcoming changes in US immigration law. Other parameters may be important contextual information, such as family status.

Yet other missing parameters may relate to a customer's preference information. For example, if the simulation reveals that there are two applicable offers: payment plan with low interest rate or lump sum with significant discount, the simulation may have missing data about the user's preference given the two applicable offers. Based on this knowledge, when the agent interacts with the real customer, he may ask the customer a preliminary question before making the offer, to get an understanding of the customer's preference. In one embodiment, the data that is discovered to be missing during the simulation may be used for process improvement and optimization, such as, for example, to revise a sales script. In the above example, the system may update the sales script to ask the preliminary question before selecting an offer to be made.

According to one embodiment, if the simulation is based on observation of a customer currently browsing a website of an enterprise supported by the contact center, signals may be provided to a web engagement server (not shown), to invite or refrain from inviting the customer into a conversation with the agent. For example, based on the observation, a particular reason for browsing the website may be deduced. The customer simulator 18 may be invoked to model an interaction with a customer having the deduced intent. If, during the simulation, it is detected that there is important information missing about the customer or the interaction to successfully complete the interaction, the web engagement server may refrain from inviting the customer to a conversation until the missing information is obtained. In this regard, the web engagement server may be configured to transmit instructions to the web site to dynamically modify the webpage to obtain the missing information, or to display a prompt (e.g. a pop-up window) asking customer for the missing information.

For example, an airline may have a webpage on its website containing information on how to fly on the airline with pets. The web engagement server may detect that a customer is lingering on this particular webpage, and assume that the customer has a question about this particular issue. The web engagement server may send a notification to the agent device 28 to initiate a simulation with a customer having this particular inquiry. In order to initiate the simulation, the simulation controller 10 may transmit a call reason of “flying with pets” as part of the initial conditions 12 for running the simulation. Upon conducting the simulation, it may be learned that the agent's ability to help the customer with this inquiry depends on knowing the specific type of pet owned by the customer. The reason may be that the agent is proficient with policies dealing with certain types of pets only. In this case, the outcome of the simulation may be to signal the web engagement server to dynamically update the webpage to prompt the user to provide information before proactively inviting the customer to a conversation on this topic.

Alternatively, instead of asking the customer for the missing information, the web engagement server may obtain the information indirectly. For example, the web engagement server may analyze the customer's online browsing behavior with the given new focus, which was ignored in the past. This could include whether or not a customer is following web navigation links related to the topic of interest, or analyzing the customer's social media history with respect to this topic.

Simulation with the customer simulator 18 may also be invoked by a supervisor for agent training purposes. The training may relate to interacting with particular types of customers, handling particular types of issues, using particular media channels, and the like. During agent training, the outcome of the interaction is compared against an expected outcome that is identified as being successful for the given scenario. The expected outcome may be set based on real, empirically derived outcomes/agent responses in the same or very similar past situations. A score may be assigned to the agent based on the comparison to rate the agent's performance.

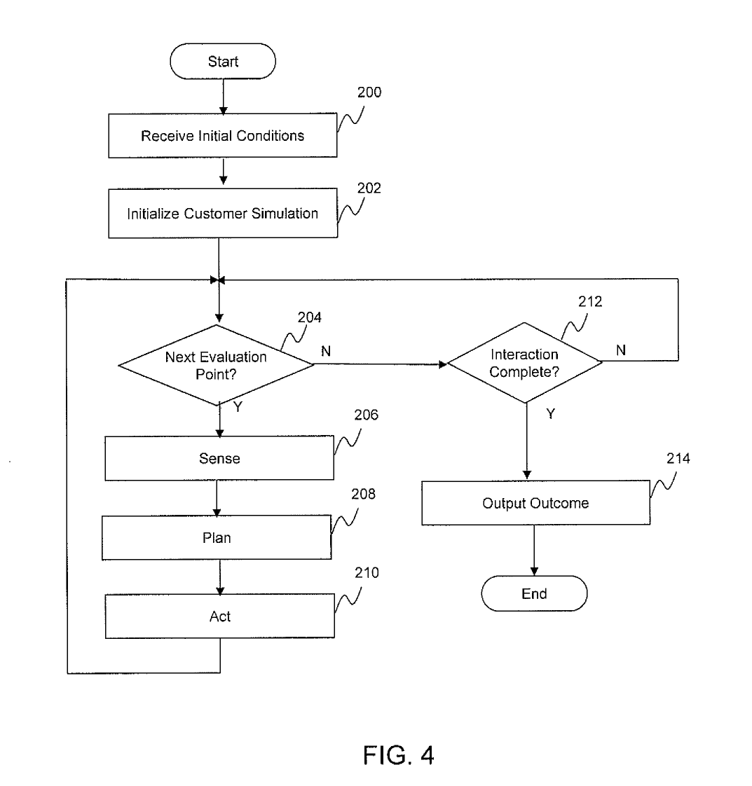

FIG. 4 is a flow diagram of a process for simulating an interaction with a customer model according to one embodiment of the invention. The process starts, and in act 200, the customer simulator 18 receives initial conditions 12 from the simulation controller 10 for invoking a simulation. The initial conditions may vary depending on the reason for the simulation. For example, if the simulation is for rehearsing for a real interaction with a real customer that is browsing a website or waiting in queue to interact with an agent, the initial conditions 12 may be information on the specific customer, including any available demographic and psychographic profiling data, history of interactions, current actions of the customer, and the like. The current actions may include browsing actions of the customer on the website, posts made by the customer on social media sites, and the like, for accurately modeling the specific real customer.

According to one embodiment, the customer simulator 18 (or some other server) may be configured to predict a current customer's intent, and feed the predicted customer intent as the initial conditions to drive the customer model. Various mechanisms may be employed to predict the customer's intent. For example, the customer simulator 18 may, based on current actions taken by the customer, his profile data, history of past interactions, and the like, identify other customers exhibiting a similar behavior and profile, and take the learned intent of those other customers as the predicted intent of the current customer. In one embodiment, semantic analysis of text input by the customer may be conducted based on, for example, search terms entered on the enterprise's website, posting of the customer on social media sites, and the like.

If the simulation is for agent training, the initial conditions 12 may include parameters (which may or may not include geographically specific, demographically specific, or psychographically specific characteristics) defining a generic or representative customer profile for conducting the training. For example, one of the attributes of the representative customer may represent the customer's emotion. If the agent is to be trained on how to handle agitated customers, the initial conditions 12 to the customer simulator may indicate an emotional state to be modeled as being “agitated.”

According to one embodiment, the selection of the scenarios for which the customer should be trained may be selected automatically based on analysis of recordings of real agent-customer interactions as described in more detail in U.S. patent application Ser. No. 14/327,476, filed on Jul. 9, 2014, the content of which is incorporated herein by reference. For example, if a trend of a particular hot topic is detected, it may be desirable to train agents to handle such topics.

Regardless of the scenario, the initial conditions 12 may also include a problem statement or interaction reason associated with the customer, as well as constraints and objectives of the interaction. An exemplary objective for an interaction may be completion of a sale. Another objective for an interaction may be completion of the interaction within a particular handle time.

In act 202, the customer simulator generates a simulation model based on the initial conditions. To start the simulation, the simulation model of the customer may be configured to emit an initiating comment. The comment may be one of various possible comments that may be appropriate given the initial conditions. The comment may be a spoken utterance if the modeled interaction is voice, a chat message if the modeled interaction is chat, and the like.

In acts 204-210, the customer simulator engages in a sensing, planning, and action steps at each evaluation point of the interaction. According to one embodiment, the evaluation point is marked by a preset event such as, for example, a clock tick output by the clock 50. The evaluation point may also be triggered by a particular event such as, for example, a particular input from the simulation controller. For example, the simulation controller may inject a state to the customer simulator relating to mood, or submit a web page click on their behalf. In another example, the customer simulator may simulate a random event such as the customer not being able to hear the agent.

Specifically with respect to the sensing step in act 206, the sensing module 52 may integrate external inputs received from its data sources, with an internal state, thereby updating a perceptual state of the simulation model. The external inputs may be data generated by the simulation controller or agent device relating to the initial conditions 12, interaction guidance 16, or agent actions 22. For example, if the modeled customer is waiting for a response from the agent, the customer's sentiment may be updated (e.g. from “neutral” to “displeased”) after a certain number of clock ticks have been sensed without receiving a response from the agent. Also, if the customer simulator were to model an agitated customer, the sensing module 52 may sense a string of messages being fired by the simulated customer at a high frequency (e.g. at every clock tick), without giving the agent an opportunity to respond. The sensing module may engage in predictive analytics based on this data to predict that the customer is agitated, and transition the customer from a “neutral” state to an “agitated!” state.

In another example, the sensing module 52 may receive data of a particular customer that is being modeled indicating that there is an unresolved interaction about the customer's phone. If the customer is waiting in queue to speak to a customer, and/or is browsing FAQs, a portion of the enterprise's website containing data related to the unresolved issue (e.g. customer is having problems with the phone's Bluetooth), or a posted query made by the customer in a product-specific forum hosted by the manufacturer, the sensing module may classify the customer's intent as relating to problems with the phone's Bluetooth. The customer's “intent” state may then be updated to reflect the deduced intent.

In yet another example, the sensing module detects that a particular customer that is being modeled just posted a positive comment on a social media site about bicycles. The sensing module may, based on this information, classify the customer as a bike enthusiast. The agent may then simulate an interaction with the customer to do an upsell on a more-expensive, highly desirable bike or logical bike accessory prior to engaging the customer in such a conversation.

The predictive analytics engaged by the sensing module 52 to predict the current state of the customer or interaction may be a close approximation of the real world, but not the exact state of the real world. Thus, according to one embodiment, the various states maintained by the sensing module 52 are represented as a probability distribution. For example, the sensing module may predict, based on available data, that a real customer being modeled is a bike enthusiast, and assign a probability to such a state based on data accrued so far. The probability of this particular state may be updated based on additional information gathered at future evaluation points.

In act 208, the planning module 54 generates one or more plans of actions to take based on the current state of the customer or interaction. According to one embodiment, the planning module 54 is configured to generate various candidate actions that could be taken, and select an action that is predicted to produce an optimal outcome given the constraints and goals of the simulation. The optimal outcome may be achieving a final goal of the simulation, an intermediary objective during the simulation, and/or the like. For example, if the customer is in an agitated state, the action that the customer could take is to ask to speak to a supervisor, send a complaint to the agent, or abandon the interaction. According to one embodiment, in selecting the action to take, the planning module approaches the problem as an optimization problem to select an action that will help accomplish a particular objective.

In act 210, the action module 56 interacts with the appropriate components of the interaction handling system 24 for executing the selected action. For example, if the action is to send a chat message containing a complaint, the action module 56 generates the chat message and forwards the message to the multimedia/social media server 116 for delivery to the agent device 28. If the action is a particular voice utterance, the action module 56 interacts with speech servers (not shown) of the interaction handling system 24 to generate the particular voice utterance based on a script generated by the action module. Notifications may also be generated for the simulation controller 10 if input is needed from the controller.

Referring again to act 204, if an evaluation point has not been triggered, a determination is made in act 212 as to whether the interaction is complete. If the answer is YES, the outcome of the simulation is output in act 214. The output may vary depending on the reason for running the simulation. For example, if the simulation is to simulate an interaction to test the outcome of a cross-sell to a specific customer, the outcome may indicate a likelihood of the sale being completed. The agent may want to run the simulation again to try a separate cross-sell object, service, or strategy, if the likelihood of success of the first cross-sell object, service, or strategy is less than a particular threshold value. In this regard, the output may include a prompt recommending that the agent take an action different from an action taken during the simulation. This recommendation may be derived from an aggregate set of previous real actions taken in similar scenarios which resulted in the desired type of cross-sell or upsell being simulated. In one embodiment, statistical models used to predict, for example, an optimal outcome may be used to make the recommendation as described in further detail in U.S. patent application Ser. No. 14/153,049, the content of which is incorporated herein by reference. According to one embodiment, a sales script used by the agent may be modified based on a command from the action module based on the simulation results.

If the simulation is for agent training, the outcome of the simulation may be a comparison of the actual outcome against an expected outcome. A score may also be output based on the comparison. For example, if the expected outcome of the simulation is a handle time less than 5 minutes, but the actual outcome is a handle time of 10 minutes, the difference of the actual handle time against the expected handle time may be output on a display coupled to, for example, the simulation controller 10. A ranking or score may also be provided based on the comparison. For example, the agent may be scored based on a degree in which the agent was able, or not able to, meet the expected handling time.

According to one embodiment, analysis of the real interactions associated with scenarios for which an agent is being trained may provide information on issues that are typically addressed during such conversations. For example, if the training relates to setting up a physical appointment at a customer's home with a technician or sales representative, analysis of real interactions relating to this topic may reveal that during such real interactions, a topic of access issues such as dogs or locked gates are brought up. In this case, the agent ranking may be based on whether the agent has asked the simulated customer about access issues. If the simulated interaction is a voice interaction, speech analytics may be used to analyze the agent's utterance to determine whether the utterance can be classified as relating to access issues.

According to one embodiment, feedback to the customer simulator 18 based on real interactions may be used for fine-tuning a given customer model. The feedback may be, for example, based on outputs from a real interaction that is conducted after or concurrently with a simulation. For example, assume that an agent, after successfully offering a cross-sell product during a simulation, proceeds to make the same offer in a real interaction with a real customer. The customer in the real interaction, however, makes an inquiry about the product that was not part of the simulation, and the cross-sell attempt in the real interaction is unsuccessful. Based on this information, the customer model for the particular customer and/or representative customer is modified to make an inquiry about the product as was done in the real interaction. The classification model may also be adjusted to lower its confidence that a cross-sell is appropriate given the interaction data available, and thus adjust the guidance (via e.g. an agent script) offered to the agent. If the simulation is run concurrently with the real interaction, the feedback may be used for an in-session adjustment of the conversation strategy.

In another example, the simulation may be an attempt to sell a vacation package to a high-status frequent flier that is successful during the simulation but not in actual attempt due to the fact that the frequent flier has children for whom the package is not appropriate. In this example, the simulation and/or real interaction may be modified to ask if the customer has children, assuming that the customer record does not have that information already.

According to some embodiments, the customer simulation system of FIG. 1 may be extended to also include an agent simulator in addition to a customer simulator 18. Such a system may be invoked to provide agent assistance and/or interaction automation during a live interaction.

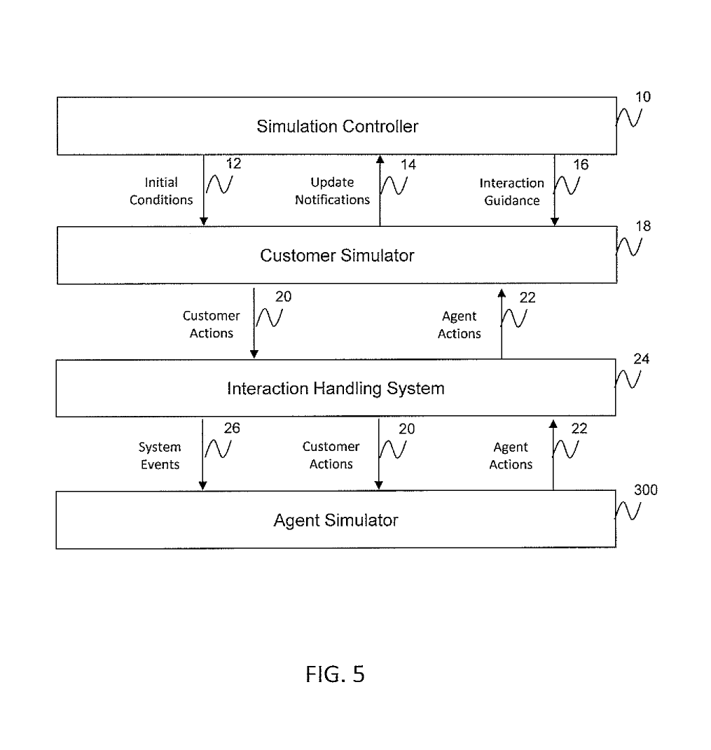

FIG. 5 is a schematic block diagram of a customer and agent simulation system according to one embodiment of the invention. The system includes all the components of FIG. 1, except that the system of FIG. 5 replaces the agent device 28 of FIG. 1 with an agent simulator 300. The agent simulator is similar to the customer simulator 18, except that instead of simulating a customer, the agent simulator simulates an agent. Although not shown in FIG. 5, a controller similar to the simulation controller 10 for customers may be provided for controlling the simulation of the agent, and an agent device similar to the agent device 28 of FIG. 1 may also be provided for allowing a live agent to engage in a real interaction based on recommendations from the agent simulator.

According to one embodiment, the agent simulator 300 provides a model of agent actions that may be tried against the customer simulator 18 for determining outcomes of the actions. In this regard, the customer simulator 18 is up-to-date with the real state of the world so that the outcome of the simulation is as close to the real outcome that would result from taking the action on a real customer. By trying the different actions and observing the outcome, the agent simulator may be configured to select the best outcome predicted to achieve a particular goal.

For example, assume that the current state of the customer simulator indicates an “agitated” state for the customer, and further assume that a set of possible actions that could be taken by the agent simulator 300 is to thank or apologize to the customer. The outcome of the “thank” action does not decrease the level of agitation of the customer, which may be sensed as an objective of the simulation, while the “apologize” action does decrease the level of agitation. In this example, the agent simulator discards the “thank” action and selects the “apologize” action as the optimal action based on the sensed objective.

According to one embodiment, given that the current state of the customer simulator is based on predictions, the actions selected as being the best action may be one that is optimal over a range of possibilities of the state of the customer simulator as opposed to a single state. For example, the customer simulator 18 may sense, based on current data, that the particular customer being modeled is a bicycle enthusiast and assign a probability to this state. The customer simulator may also sense, based on the customer profile, that the customer purchased a bicycle 6 months ago, and assign a probability to this state. Given these current states, the agent simulator 300 may attempt various actions. A first action may be to suggest to the customer that he purchase a bicycle. A second action may be to inquire of the simulated customer as to whether he has heard of the latest advances in carbon fiber wheel technology. The second action may be chosen as the optimal action given that it is robust and applies even if the customer has not purchased a bicycle, and even if the customer is not a true bicycle enthusiast.

According to one embodiment, a selected optimal action may be output by the agent simulator 300 as a recommended action for a real agent to take. The recommendation may be provided, for example, as a display on the agent device with details on what the action should be. For example, if the action is utterance of a particular statement, the substance of the utterance may be displayed on the agent device in the form of, for example, an agent script. In this regard, the agent script is adjusted dynamically based on the simulation. Feedback received after taking the action on the real customer may be used for fine tuning the agent simulator 300 and/or customer simulator 18.

In the various embodiments, the term interaction is used generally to refer to any real-time and non-real time interaction that uses any communication channel including, without limitation telephony calls (PSTN or VoIP calls), emails, vmails (voice mail through email), video, chat, screen-sharing, text messages, social media messages, web real-time communication (e.g. WebRTC calls), forum queries and replies, and the like.

In addition, although the various embodiments are described in terms of simulating an inbound interaction from a customer, a person of skill in the art should recognize that an agent/worker of a contact center/physical branch office could use the simulation for an upcoming outbound call with the customer, of for an in-person appointment in the physical branch office.

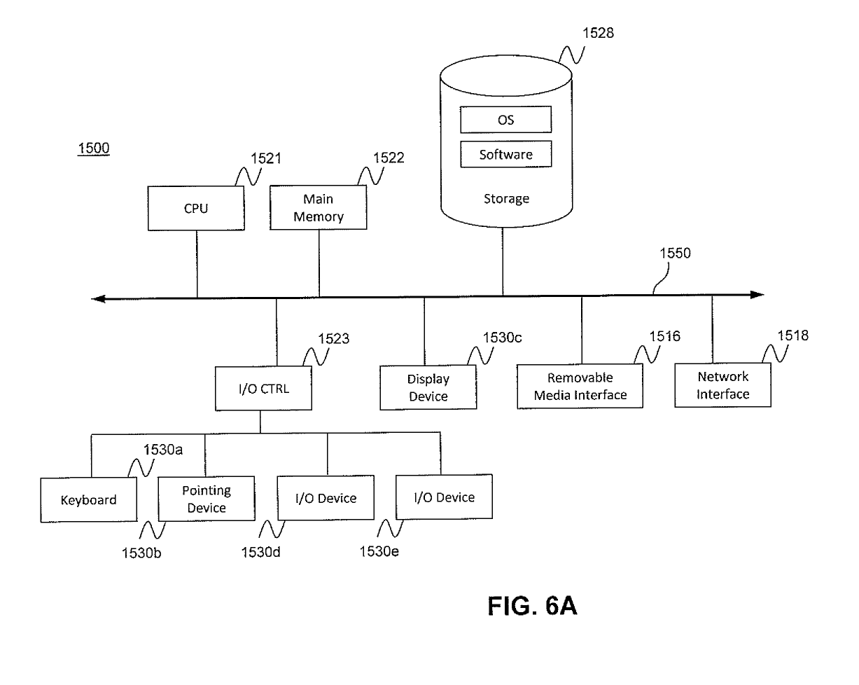

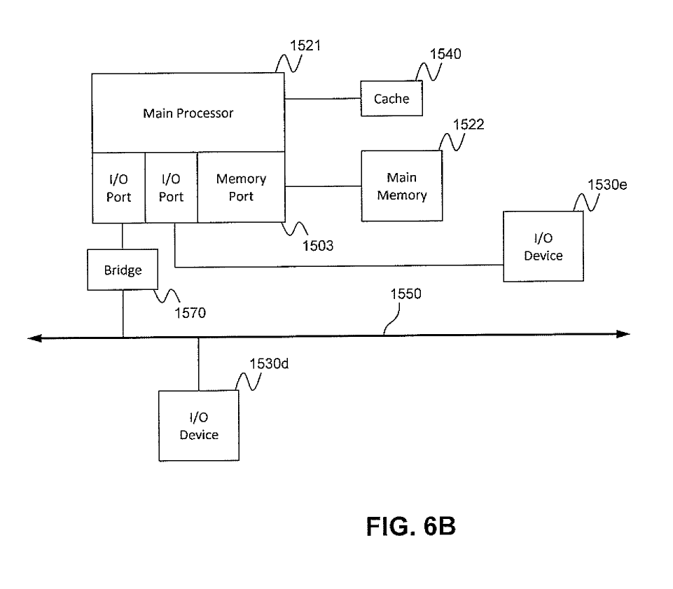

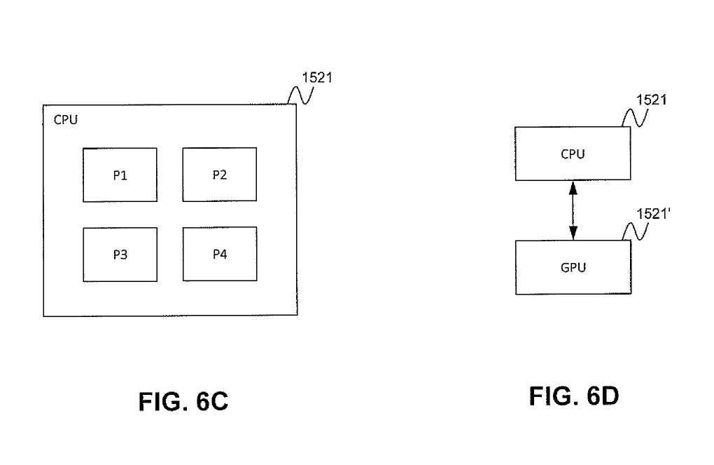

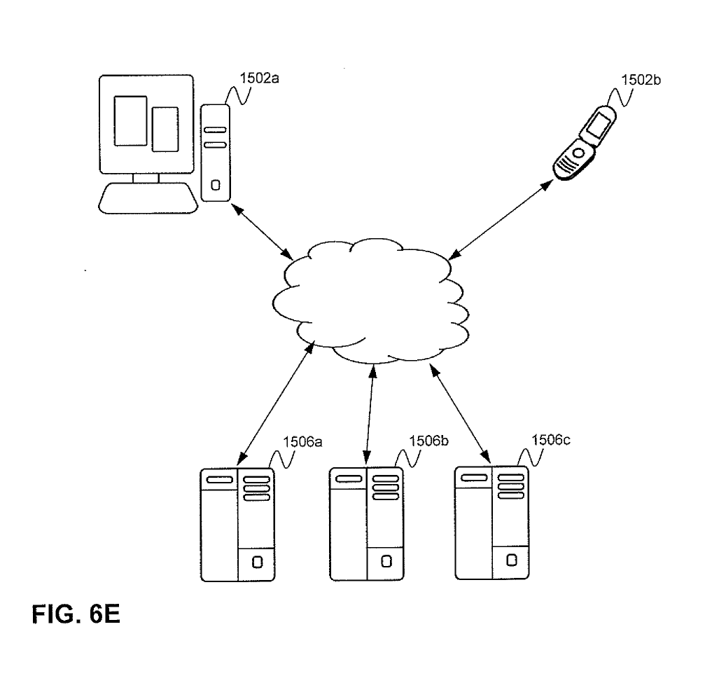

Each of the various servers, controllers, switches, gateways, engines, and/or modules (collectively referred to as servers) in the afore-described figures may be a process or thread, running on one or more processors, in one or more computing devices 1500 (e.g., FIG. 6A, FIG. 6B), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that a computing device may be implemented via firmware (e.g. an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers, and other modules.

The various servers may be located on a computing device on-site at the same physical location as the agents of the contact center or may be located off-site (or in the cloud) in a geographically different location, e.g., in a remote data center, connected to the contact center via a network such as the Internet. In addition, some of the servers may be located in a computing device on-site at the contact center while others may be located in a computing device off-site, or servers providing redundant functionality may be provided both via on-site and off-site computing devices to provide greater fault tolerance. In some embodiments of the present invention, functionality provided by servers located on computing devices off-site may be accessed and provided over a virtual private network (VPN) as if such servers were on-site, or the functionality may be provided using a software as a service (SaaS) to provide functionality over the internet using various protocols, such as by exchanging data using encoded in extensible markup language (XML) or JavaScript Object notation (JSON).

FIG. 6A and FIG. 6B depict block diagrams of a computing device 1500 as may be employed in exemplary embodiments of the present invention. Each computing device 1500 includes a central processing unit 1521 and a main memory unit 1522. As shown in FIG. 6A, the computing device 1500 may also include a storage device 1528, a removable media interface 1516, a network interface 1518, an input/output (I/O) controller 1523, one or more display devices 1530c, a keyboard 1530a and a pointing device 1530b, such as a mouse. The storage device 1528 may include, without limitation, storage for an operating system and software. As shown in FIG. 6B, each computing device 1500 may also include additional optional elements, such as a memory port 1503, a bridge 1570, one or more additional input/output devices 1530d, 1530c and a cache memory 1540 in communication with the central processing unit 1521. The input/output devices 1530a, 1530b, 1530d, and 1530e may collectively be referred to herein using reference numeral 1530.

The central processing unit 1521 is any logic circuitry that responds to and processes instructions fetched from the main memory unit 1522. It may be implemented, for example, in an integrated circuit, in the form of a microprocessor, microcontroller, or graphics processing unit (GPU), or in a field-programmable gate array (FPGA) or application-specific integrated circuit (ASIC). The main memory unit 1522 may be one or more memory chips capable of storing data and allowing any storage location to be directly accessed by the central processing unit 1521. As shown in FIG. 6A, the central processing unit 1521 communicates with the main memory 1522 via a system bus 1550. As shown in FIG. 6B, the central processing unit 1521 may also communicate directly with the main memory 1522 via a memory port 1503.

FIG. 6B depicts an embodiment in which the central processing unit 1521 communicates directly with cache memory 1540 via a secondary bus, sometimes referred to as a backside bus. In other embodiments, the central processing unit 1521 communicates with the cache memory 1540 using the system bus 1550. The cache memory 1540 typically has a faster response time than main memory 1522. As shown in FIG. 6A, the central processing unit 1521 communicates with various I/O devices 1530 via the local system bus 1550. Various buses may be used as the local system bus 1550, including a Video Electronics Standards Association (VESA) Local bus (VLB), an Industry Standard Architecture (ISA) bus, an Extended Industry Standard Architecture (EISA) bus, a MicroChannel Architecture (MCA) bus, a Peripheral Component Interconnect (PCI) bus, a PCI Extended (PCI-X) bus, a PCI-Express bus, or a NuBus. For embodiments in which an I/O device is a display device 1530c, the central processing unit 1521 may communicate with the display device 1530c through an Advanced Graphics Port (AGP). FIG. 6B depicts an embodiment of a computer 1500 in which the central processing unit 1521 communicates directly with I/O device 1530e. FIG. 6B also depicts an embodiment in which local busses and direct communication are mixed: the central processing unit 1521 communicates with I/O device 1530d using a local system bus 1550 while communicating with I/O device 1530e directly.

A wide variety of I/O devices 1530 may be present in the computing device 1500. Input devices include one or more keyboards 1530a, mice, trackpads, trackballs, microphones, and drawing tablets. Output devices include video display devices 1530c, speakers, and printers. An I/O controller 1523, as shown in FIG. 6A, may control the I/O devices. The I/O controller may control one or more I/O devices such as a keyboard 1530a and a pointing device 1530b, e.g., a mouse or optical pen.

Referring again to FIG. 6A, the computing device 1500 may support one or more removable media interfaces 1516, such as a floppy disk drive, a CD-ROM drive, a DVD-ROM drive, tape drives of various formats, a USB port, a Secure Digital or COMPACT FLASH^{TM} memory card port, or any other device suitable for reading data from read-only media, or for reading data from, or writing data to, read-write media. An I/O device 1530 may be a bridge between the system bus 1550 and a removable media interface 1516.

The removable media interface 1516 may for example be used for installing software and programs. The computing device 1500 may further comprise a storage device 1528, such as one or more hard disk drives or hard disk drive arrays, for storing an operating system and other related software, and for storing application software programs. Optionally, a removable media interface 1516 may also be used as the storage device. For example, the operating system and the software may be run from a bootable medium, for example, a bootable CD.

In some embodiments, the computing device 1500 may comprise or be connected to multiple display devices 1530c, which each may be of the same or different type and/or form. As such, any of the I/O devices 1530 and/or the I/O controller 1523 may comprise any type and/or form of suitable hardware, software, or combination of hardware and software to support, enable or provide for the connection to, and use of, multiple display devices 1530c by the computing device 1500. For example, the computing device 1500 may include any type and/or form of video adapter, video card, driver, and/or library to interface, communicate, connect or otherwise use the display devices 1530e. In one embodiment, a video adapter may comprise multiple connectors to interface to multiple display devices 1530c. In other embodiments, the computing device 1500 may include multiple video adapters, with each video adapter connected to one or more of the display devices 1530c. In some embodiments, any portion of the operating system of the computing device 1500 may be configured for using multiple display devices 1530c. In other embodiments, one or more of the display devices 1530c may be provided by one or more other computing devices, connected, for example, to the computing device 1500 via a network. These embodiments may include any type of software designed and constructed to use the display device of another computing device as a second display device 1530c for the computing device 1500. One of ordinary skill in the art will recognize and appreciate the various ways and embodiments that a computing device 1500 may be configured to have multiple display devices 1530c.

A computing device 1500 of the sort depicted in FIG. 6A and FIG. 6B may operate under the control of an operating system, which controls scheduling of tasks and access to system resources. The computing device 1500 may be running any operating system, any embedded operating system, any real-time operating system, any open source operating system, any proprietary operating system, any operating systems for mobile computing devices, or any other operating system capable of running on the computing device and performing the operations described herein.

The computing device 1500 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 1500 may have different processors, operating systems, and input devices consistent with the device.

In other embodiments the computing device 1500 is a mobile device, such as a Java-enabled cellular telephone or personal digital assistant (PDA), a smart phone, a digital audio player, or a portable media player. In some embodiments, the computing device 1500 comprises a combination of devices, such as a mobile phone combined with a digital audio player or portable media player.

As shown in FIG. 6C, the central processing unit 1521 may comprise multiple processors P1, P2, P3, P4, and may provide functionality for simultaneous execution of instructions or for simultaneous execution of one instruction on more than one piece of data. In some embodiments, the computing device 1500 may comprise a parallel processor with one or more cores. In one of these embodiments, the computing device 1500 is a shared memory parallel device, with multiple processors and/or multiple processor cores, accessing all available memory as a single global address space. In another of these embodiments, the computing device 1500 is a distributed memory parallel device with multiple processors each accessing local memory only. In still another of these embodiments, the computing device 1500 has both some memory which is shared and some memory which may only be accessed by particular processors or subsets of processors. In still even another of these embodiments, the central processing unit 1521 comprises a multicore microprocessor, which combines two or more independent processors into a single package, e.g., into a single integrated circuit (IC). In one exemplary embodiment, depicted in FIG. 6D, the computing device 1500 includes at least one central processing unit 1521 and at least one graphics processing unit 1521′.

In some embodiments, a central processing unit 1521 provides single instruction, multiple data (SIMD) functionality, e.g., execution of a single instruction simultaneously on multiple pieces of data. In other embodiments, several processors in the central processing unit 1521 may provide functionality for execution of multiple instructions simultaneously on multiple pieces of data (MIMD). In still other embodiments, the central processing unit 1521 may use any combination of SIMD and MIMD cores in a single device.

A computing device may be one of a plurality of machines connected by a network, or it may comprise a plurality of machines so connected. FIG. 6E shows an exemplary network environment. The network environment comprises one or more local machines 1502a, 1502b (also generally referred to as local machine(s) 1502, client(s) 1502, client node(s) 1502, client machine(s) 1502, client computer(s) 1502, client device(s) 1502, endpoint(s) 1502, or endpoint node(s) 1502) in communication with one or more remote machines 1506a, 1506b, 1506c (also generally referred to as server machine(s) 1506 or remote machine(s) 1506) via one or more networks 1504. In some embodiments, a local machine 1502 has the capacity to function as both a client node seeking access to resources provided by a server machine and as a server machine providing access to hosted resources for other clients 1502a, 1502b. Although only two clients 1502 and three server machines 1506 are illustrated in FIG. 6E, there may, in general, be an arbitrary number of each. The network 1504 may be a local-area network (LAN), e.g., a private network such as a company Intranet, a metropolitan area network (MAN), or a wide area network (WAN), such as the Internet, or another public network, or a combination thereof.

The computing device 1500 may include a network interface 1518 to interface to the network 1504 through a variety of connections including, but not limited to, standard telephone lines, local-area network (LAN), or wide area network (WAN) links, broadband connections, wireless connections, or a combination of any or all of the above. Connections may be established using a variety of communication protocols. In one embodiment, the computing device 1500 communicates with other computing devices 1500 via any type and/or form of gateway or tunneling protocol such as Secure Socket Layer (SSL) or Transport Layer Security (TLS). The network interface 1518 may comprise a built-in network adapter, such as a network interface card, suitable for interfacing the computing device 1500 to any type of network capable of communication and performing the operations described herein. An I/O device 1530 may be a bridge between the system bus 1550 and an external communication bus.

According to one embodiment, the network environment of FIG. 6E may be a virtual network environment where the various components of the network are virtualized. For example, the various machines 1502 may be virtual machines implemented as a software-based computer running on a physical machine. The virtual machines may share the same operating system. In other embodiments, different operating system may be run on each virtual machine instance. According to one embodiment, a “hypervisor” type of virtualization is implemented where multiple virtual machines run on the same host physical machine, each acting as if it has its own dedicated box. Of course, the virtual machines may also run on different host physical machines.

Other types of virtualization is also contemplated, such as, for example, the network (e.g. via Software Defined Networking (SDN)). Functions, such as functions of the session border controller and other types of functions, may also be virtualized, such as, for example, via Network Functions Virtualization (NFV).

In the various embodiments, the term interaction is used generally to refer to any real-time and non-real time interaction that uses any communication channel including, without limitation telephony calls (PSTN or VoIP calls), emails, vmails (voice mail through email), video, chat, screen-sharing, text messages, social media messages, web real-time communication (e.g. WebRTC calls), and the like.

It is the Applicant's intention to cover by claims all such uses of the invention and those changes and modifications which could be made to the embodiments of the invention herein chosen for the purpose of disclosure without departing from the spirit and scope of the invention. The particular manner in which template details are presented to the user may also differ. Thus, the present embodiments of the invention should be considered in all respects as illustrative and not restrictive, the scope of the invention to be indicated by claims and their equivalents rather than the foregoing description.

1. A method for simulating an interaction between a customer and an agent of a customer contact center, the method comprising:
receiving, by a processor, input conditions for simulating the interaction;
generating, by the processor, a model of the customer based on the input conditions;
receiving, by the processor, a first action from an agent device associated with the agent;
updating, by the processor, a state of the simulation model based on the first action;
identifying, by the processor, a second action of the simulation model in response to the updated state;
executing, by the processor, the second action;
determining, by the processor, an outcome of the simulation; and
providing the outcome, by the processor, to the agent device, wherein in response to the outcome, the agent is prompted to take an action different from the second action.

2. The method of claim 1, wherein the simulation is invoked by a simulation controller accessible to the agent device for rehearsing a real interaction between the customer and the agent.

3. The method of claim 2 further comprising:
receiving, by the processor, feedback from the real interaction between the customer and the agent; and
modifying the model of the customer based on the feedback.

4. The method of claim 1, wherein the simulation is invoked by a simulation controller for training the agent for handling a particular type of interaction.

5. The method of claim 4, wherein the input conditions for generating the model of the customer are based on the particular type of interaction for which the agent is to be trained.

6. The method of claim 5, wherein the input conditions include an expected outcome of the simulation, the method further comprising:
comparing, by the processor, the outcome of the simulation with the expected outcome; and
generating a score for the agent based on the comparing.

7. The method of claim 1, further comprising:
predicting, by the processor, a customer intent, wherein the input conditions include the predicted customer intent.

8. The method of claim 1, wherein the identifying of the second action includes selecting the second action amongst a plurality of candidate actions.

9. The method of claim 7, wherein the input conditions include an objective of the interaction, and the second action is for achieving the objective.

10. The method of claim 1, wherein the prompting the agent to take an action different from the second action includes dynamically modifying, by the processor, an agent script used by the agent to guide the agent during a particular interaction.

11. A system for simulating an interaction between a customer and an agent of a customer contact center, the system comprising:
processor; and
memory, wherein the memory includes instructions that, when executed by the processor, cause the processor to:
receive input conditions for simulating the interaction;
generate a model of the customer based on the input conditions;
receive a first action from an agent device associated with the agent;
update a state of the simulation model based on the first action;
identify a second action of the simulation model in response to the updated state;
execute the second action;
determine an outcome of the simulation; and
provide the outcome to the agent device, wherein in response to the outcome, the agent is prompted to take an action different from the second action.

12. The system of claim 11, wherein the simulation is invoked by a simulation controller accessible to the agent device for rehearsing a real interaction between the customer and the agent.

13. The system of claim 12, wherein the instructions further cause the processor to:
receive feedback from the real interaction between the customer and the agent; and
modify the model of the customer based on the feedback.

14. The system of claim 11, wherein the simulation is invoked by a simulation controller for training the agent for handling a particular type of interaction.

15. The system of claim 14, wherein the input conditions for generating the model of the customer are based on the particular type of interaction for which the agent is to be trained.

16. The system of claim 15, wherein the input conditions include an expected outcome of the simulation, wherein the instructions further cause the processor to:
compare the outcome of the simulation with the expected outcome; and
generate a score for the agent based on the comparing.

17. The system of claim 11, wherein the instructions further cause the processor to:
predict a customer intent, wherein the input conditions include the predicted customer intent.

18. The system of claim 11, wherein the instructions that cause the processor to identify the second action include instructions that cause the processor to select the second action amongst a plurality of candidate actions.

19. The system of claim 17, wherein the input conditions include an objective of the interaction, and the second action is for achieving the objective.

20. The system of claim 11, wherein the instructions cause the processor to dynamically modify an agent script used by the agent to guide the agent during a particular interaction.

21. The system of claim 11 further comprising:
a clock for providing an output signal, wherein the output signal is included as part of the input conditions for simulating the interaction.
